(19) United States
(12) Patent Application Publication
(10) Pub. No.: US 2014/0304659 A1
(43) Pub. Date: Oct. 9, 2014

(54) MULTIMEDIA EARLY CHILHOOD JOURNAL TABLET

(71) Applicant: Abdul El-Zarif, Auburn, WA (US)

(72) Inventor: Abdul El-Zarif, Auburn, WA (US)

(21) Appl. No.: 14/217,401

(22) Filed: Mar. 17, 2014

Related U.S. Application Data
(60) Provisional application No. 61/801,550, filed on Mar. 15, 2013.

(51) Int. Cl. G06F 3/0481; G06F 3/0488; G06F 3/0484

(52) U.S. Cl. CPC G06F 3/04817; G06F 3/04842; G06F 3/0488
USPC 715/846

(57) ABSTRACT

The instant disclosure is directed to a novel multimedia computer tablet for journaling events and milestones primarily that occur in early childhood, as an electronic baby book or journal. The inventive tablet can operate as an electronic photo album and as a familiar computer tablet, displaying photos, slides shows and videos, including sound and text editing. The invention comprises a wireless communication component for web access. A novel Android-based operating system is disclosed, featuring simple photo editing.

### CROSS-REFERENCE TO RELATED APPLICATIONS

This application claims the benefit of U.S. Provisional Application No. 61/801,550 filed on Mar. 15, 2013.

### FIELD OF THE INVENTION

This invention relates to electronic computer tablet devices for multimedia journaling, specifically for journaling early childhood events and milestones.

### SUMMARY

The invention is a specialized electronic computer tablet device for replacing the journal, calendar, and books associated with keeping track of the first few years of a child's life memories. Like baby books used in the past, users will use this invention to document the life and activities of their children. It will hold pictures, audio, and video files associated with the subject the owner of the device decides to dedicate it to.

The invention is novel conceptually. It is between an electronic picture frame and a full tablet. It has the appeal of an electronic picture frame that will scroll through pictures on it while it is in stand-by mode, while having video and photo editing features, as well as a browser functions allowing for multi-media file sharing over a wide range of email and social media. While the basic hardware foundation will allow a user to add applications that is normally associated with a tablet computer, the main purpose of the device is to document a child's growth history digitally as people used to with specific photo albums dedicated to children called baby books. This device will hold the memories of the birth, first steps, first words, and any other documentation of history the parents feel pertinent to hold on to as important in the child's development and/or history.

The inventive computer tablet comprises a touch screen-interactive operating system, a basic photo viewer with slide-show capabilities that can handle file types including and not limited to: TIFF, JPEG, BMP, PNG, and GIF. The inventive computer tablet will also have a basic video player that will play audio handling formats including, but not limited to: MP3 and WAV (for audio), MP4, FLV, AVI, MOV, MPG, WMV and 3GP.

Also comprised by the invention is basic editing system for editing images, audio, and video so that users are able to customize their data. This will include a text editor to add captions, and a set of templates for borders.

The inventive computer tablet further comprises wireless (Wi-Fi) electronics to enable browser software to access the internet, entailing downloading and uploading files from the web, including downloadable applications. Lastly, the inventive computer tablet further comprises an integrated CCD camera.

### DETAILED DESCRIPTION

The invention comprises computer executable software comprising an operating system based on an Android 4.0 platform. The human-machine interface of the operation system comprises a touch screen GUI and physical button to support the main features. The main screen of the touch screen has three sections that can be accessed by the user pressing the screen over the icons. The left icon is the picture/video sections where the user can view, store, and edit pictures and videos of their child. The middle icon is a journal where memory entries can be logged such as baby's first word, first step, etc. The right icon is a calendar and timeline of the events stored in the physical memory. All these main areas are interconnected. If something is logged into the journal the user will then be able to make a link to the calendar and timeline. If the user is in the calendar they can press the link that is within a date and it will take them to that journal entry. The same will be true of pictures and video. If there is a picture or video entry that is involved with a journal entry the user will be able to move from one to the other using a hyperlink. Journal entries, pictures, and video can be set to automatically make an entry on the time line, and these dates and times can be adjusted to suit the user.

The menu button will allow the user to access the applications on the device which include, but not necessarily limited to, a browser app, a text editor, a Facebook app, a hand and foot printing scanner app, a camera app to control the cameras on the device, and a basic audio recording app.

The system features of the invention will now be described.

System Feature 1—Picture, Video and Audio Book

This feature is one of the three main “books” provided by the device. It is the area of the device that stores, records, and edits all the audio and visual data the user wishes to keep of their child. It is interconnected to the other two main features of the device and is of a High Priority. The main icon for this feature is on the left-hand side of the screen. Upon being touched the device will go to the main picture file folder system. The user can make and organize these folders in any manner he or she sees fit just like a standard file system. The folders open once touched and the picture, audio, and video files contained within are presented in a tiled list. Each file may be viewed individually by touching them, or the user can press the menu button to select a gallery view or to play pictures in a slideshow format. Videos and audio content will be played using the basic player that comes installed on the device. Files may be recorded using the cameras and microphone on the device, downloaded from the internet, or imported from another device such as a smart phone, camera, or computer.

To implement these features, unique code blocks are incorporated into the operating system software are a graphics engine within the operating system to view pictures, play sounds, and view video. The graphics engine component can be written using OpenGL. Other code blocks include a touch screen interface control block, a file system code block for maintaining a user file system that is separate from the main device file folder system to separate user data from the main data operating the device.

System Feature 2—Baby Journal

This feature is the second of the three main “books” provided by this device. It is the area of the device that allows the user to document the different things that happened throughout the day. Each entry will be logged by date and time pulled automatically from the device's internal clock. Users may edit this entry time to reflect when the event actually occurred, or can simply keep the entry time and describe the event and about when it happened. It is interconnected to the other two main features of the device, for example, an entry will automatically be placed on the timeline part of the calendar to reflect the journal entry. The main icon for this feature will be in the middle of the screen between the other two “book” icons. Once touched the device will open the journal to the current entry where the user may add a new entry. The user may touch the menu button to go to a table of contents which will be ordered by year, month, day, and then time. The user can touch a value in the table of contents to open to that journal entry to read and/or edit the journal. If a picture, video, audio recording, or special event calendar date is associated with a journal entry, the user will be able to touch a hyperlink and the device will open that data associated with the journal entry.

System Feature 3—Calendar/Timeline

This is the third “book” and also has a priority level of High. It is a calendar that keeps track of important dates for upcoming and past events. It also has a timeline which keeps a record of the different events and mile stones in the child's development. Entries can be made to the timeline directly or via the Journal. A section for the calendar has “stickers” which have different things on them like baby's first step, with an image depicting the event. These can be moved from the “sticker” section and placed on the calendar day.

The icon for this feature will be on the right-hand side of the screen. Once touched, the screen will open to two icons. The one on the left will depict a calendar, the one on the right a timeline. Touching the calendar opens a traditional month format calendar page showing the current month with the current day highlighted. At the top of each side of the calendar is an arrow to scroll backward or forward throughout the calendar. Days may be touched to open them individually to add events. If the menu button is pressed it allows the user to open the “sticker” section and select “sticker” icons to be added onto different days. Hyperlinks to journal entries and pictures/video objects can be found on different days.

Touching the timeline icon opens the timeline which is a year broken down to months in a list. If the user touches a month it will zoom into that month which is broken down to a list of days, and when a day icon is pressed it will zoom in on that day which is broken into hours, which can be zoomed in on to quarter hours. Life events can be logged into this manually or added by the journal and calendar. Hyperlinks to the events will take the user to different books depicting the entries, photos, and/or videos.

System Feature 4—Application Menu

This is a separate menu where the secondary application functions will be held and is of Medium priority. This is where the browser, camera, Facebook, audio recorder, fingerprint/footprint scanner, and other downloaded apps will be accessed. While some of these secondary applications may seem necessary, they only augment the basic functionality of the device and add user experience enhancement.

When the main screen is open the user presses a menu button that opens a new screen that has all the secondary applications in an icon list with its name. The user can slide their finger up and down the screen to scroll through the list, and then press the desired icon to start the application. The application will then function in the manner designed by the manufacturer of the application. All applications will be Android compatible and function using the touch screen.

User Interfaces

The main user interface is a 5-point capacitive touch screen that measures a change state in the minute electrical current held by sensors within the screen. The screen can be scrolled both horizontally and vertically in four different directions and may be scrolled forward or back (zooming in and out) on the z-axis by a “pinching” motion on the screen to zoom out and a finger spreading motion to zoom in. The device has a main power button to switch on the device, turn it off, put it in sleep mode, wake it from sleep mode, and to reset the device. There is a menu button with various basic functions depending on what feature of the device is currently open. The main function, used on the main screen, takes the user to the application menu.

There are three other buttons on the device. Two of them are for adjusting the volume of the device. The last button is a “Back” button which allows the user to easily move back one or more screens when using features and applications.

Hardware Interfaces

This device will use standard USB Host protocol in order to communicate using a hard-line between itself and other devices such as a PC, laptop, a tablet device, a smart phone, etc. The camera will interface with the board, and thus with the rest of the device using standard chipset coding hard-coded to the chipset during manufacture. The speakers and microphone will also be hard-coded into the chipset at manufacture. The inventive tablet may be stocked with IEEE802.11 b/g/n Wi-Fi that uses basic http protocol interfaces and IP/TCP network protocols to connect to other devices on a closed network or over the World Wide Web (www). The device also comes with a TF card slot for external memory and a headphone port.

Software Interfaces

All software will interconnect using basic Android and Java Object Oriented Programming techniques.

Communications Interfaces

The inventive tablet device uses Wi-Fi and USB to communicate to other devices. The basic communication protocols associated with these two standardized formats will be used. More information is needed for the exact nature of the USB protocols which will already be in place from the hardware manufacturer and will be added here later. The Wi-Fi protocols that the device will use when using a browser function to connect to the internet will be basic http, with the security of standard IP/ICP connection network protocols that are used for almost every device currently used on the market. IPv4 and Ipv6 will be available within the networking to allow for the future of IP addressing.

Flow Chart

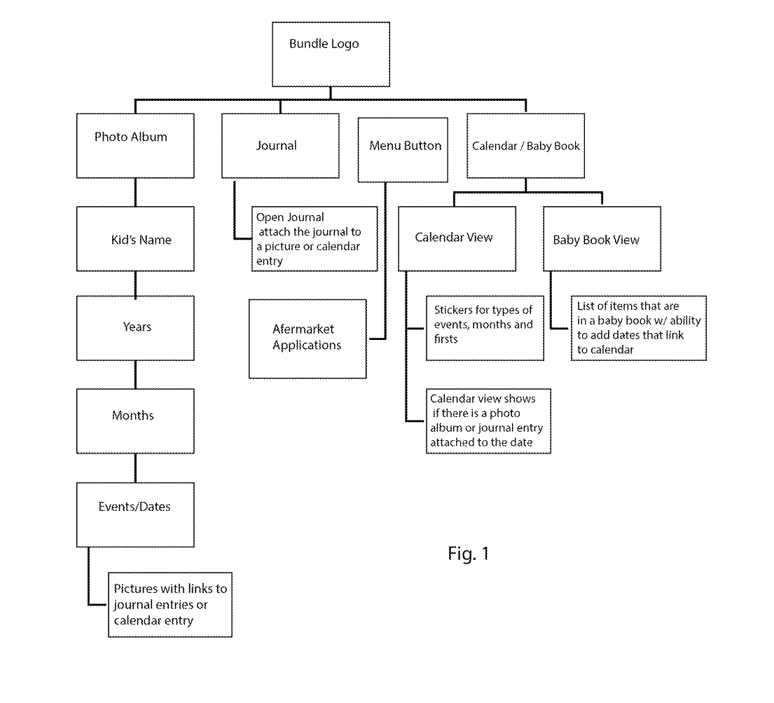

An exemplary flow chart is shown in FIG. 1.

Glossary of Terms

Capacitive—The property of a system that enables it to store electric charge.

Chipset—A highly integrated circuit on the motherboard of a computer that controls many of its data transfer functions.

CPU—Central Processing Unit: the key component of a computer system, which contains the circuitry necessary to interpret and execute program instructions.

Encryption—The process of encoding a message so that it can be read only by the sender and the intended recipient.

Hyperlinks—A word, phrase, picture, icon, etc, in a computer document on which a user may click to move to another part of the document or to another document.

IEEE—Institute of Electrical and Electronics Engineers: the institute that sets the standards for all engineering projects.

IP/ICP—Internet Protocol/Internet Control Protocol: the protocol standards for connecting to and identifying connecting devices over a network or the world wide web.

IPv4—Internet Protocol version 4: the 4^{th} version of internet protocol and addressing that uses 32-bit addresses for communication.

IPv6—Internet Protocol version 6: the 6^{th} version of internet protocol and addressing that uses 128-bit addresses for communication and will be capable of having enough different internet addresses for the foreseeable future.

OOP—Object Oriented Programming: a type of programming where each part of the program is modular and can spawn new subclasses with little need for rewriting entire sets of code. It is highly reusable, flexible, and powerful.

OpenGL—Open Graphics Library: a cross-language, multi-platform API (Applications Programming Interface) for rendering 2D and 3D computer graphics. The API is typically used to interact with a Graphics Processing Unit, to achieve hardware- accelerated rendering

OS—An Operating System which is the main program that runs all the functions of a device or hardware system in a format that allows a user to interface and use the functions.

Proprietary—Manufactured and sold only by the owner of the patent, formula, brand name, or trademark associated with the product.

TF Card—TF stands for Trans Flash and is the small removable memory card found in digital cameras, cell phones, and other devices. TF cards have standardized adapters that look and act like SD cards (another form of memory) in order to transfer data to and from the TF card and a PC or other device that uses SD cards instead.

USB—Universal Serial Bus: a connection technology for attaching peripheral devices to a computer, providing fast data exchange.

Wi-Fi—a popular technology that allows an electronic device to exchange data wirelessly (using radio waves) over a computer network, including high-speed Internet connections.

1. A method of associating digital media with descriptive data, comprising:
(i) providing a microprocessor-based media tablet having a touch screen and a GUI- based operating system ;
(ii) touching a first icon displayed on said touch screen to open one or more digital audio and visual media files stored in RAM memory on said media tablet;
(iii) touching a second icon displayed on said touch screen to open digital entry log files to enter information associated with the one or more digital audio and/or visual media files open in the previous step; and
(iv) touching a third icon displayed on said touch screen to open one or more calendar or timeline files to link data stored in said one or more digital entry log files and/or said one or more digital media files with data in said one or more calendar or timeline files.
